(19) United States
(12) Patent Application Publication
(10) Pub. No.: US 2017/0295942 A1
(43) Pub. Date: Oct. 19, 2017

(54) Surface Mounted Headboard

(71) Applicant: Bernard Ferris, Union, NJ (US)

(72) Inventor: Bernard Ferris, Union, NJ (US)

(21) Appl. No.: 15/490,117

(22) Filed: Apr. 18, 2017

Related U.S. Application Data
(60) Provisional application No. 62/324,126, filed on Apr. 18, 2016.

(51) Int. Cl. A47C 19/02; F16B 47/00; A47C 31/00

(52) U.S. Cl. CPC A47C 19/022; A47C 31/00; F16B 47/003

(57) ABSTRACT

A surface mounted headboard. The surface mounted headboard includes a base having a front side and a rear side. A cover is removably securable over the base. A bubble level is removably secured to either the base or the cover for facilitating proper alignment of the headboard during installation. One or more removable fasteners are disposed on the cover, such that the one or more fasteners are positioned over the rear side of the base when the cover is secured thereto. In an exemplary embodiment, the fasteners include a removable adhesive material configured to secure the headboard to a surface. The surface mounted headboard may be utilized to provide a headboard above a bed that does not have an integral headboard, or may be secured to an existing headboard to provide additional cushioning thereon.

### CROSS REFERENCE TO RELATED APPLICATIONS

This application claims the benefit of U.S. Provisional Application No. 62/324,126 filed on Apr. 18, 2016. The above identified patent application is herein incorporated by reference in its entirety to provide continuity of disclosure.

### FIELD OF THE INVENTION

The present invention relates to headboards. More specifically, the present invention provides a headboard that is securable to a surface via a fastener such as a removable adhesive material.

### BACKGROUND OF THE INVENTION

Many individuals enjoy having a headboard behind their bed for decorative or comfort purposes. Traditional headboards are typically integral to the bed. It can be difficult to assemble a bed with an attached headboard properly. Improper assembly of beds with large attached headboards can lead to an unsightly appearance and could lead to the headboard falling from its mounting point, potentially causing injury.

Additionally, a large number of beds do not have attached headboards. It can be difficult or impossible to attach a headboard to such beds, since they were not initially designed to have such an attachment. Therefore, it is desirable to provide a headboard that can be easily mounted to a surface via a removable fastener such as a removable adhesive material.

In light of the devices disclosed in the prior art, it is submitted that the present invention substantially diverges in design elements from the prior art and consequently it is clear that there is a need in the art for an improvement to existing headboards. In this regard the instant invention substantially fulfills these needs.

### SUMMARY OF THE INVENTION

In view of the foregoing disadvantages inherent in the known types of headboards now present in the prior art, the present invention provides a surface mounted headboard wherein the same can be utilized for providing convenience for the user when mounting a headboard to a surface. The present system comprises a base having a front side and rear side. A cover is removably securable over the base. One or more removable fasteners are disposed on the cover, such that the one or more removable fasteners are positioned over a rear side of the base when the cover is secured thereto. The one or more removable fasteners, which can include hook and loop material, a removable adhesive material, or other removable fasteners, allow the headboard to be quickly and easily mounted to a surface, such as wall above a bed that does not have an existing headboard, or the surface of an existing headboard. The removable fasteners allow the headboard to be uninstalled without leaving residue behind on the surface to which it was mounted.

One object of the present invention is to provide a surface mounted headboard that is lightweight and easy to install.

Another object of the present invention is to provide a surface mounted headboard that can be secured to a surface and removed without leaving residue behind on the surface.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the surface mounted headboard.

FIG. 2 shows a rear perspective view of the surface mounted headboard.

FIG. 3 shows a bottom view of the surface mounted headboard.

### DETAILED DESCRIPTION OF THE INVENTION

Reference is made herein to the attached drawings. Like reference numerals are used throughout the drawings to depict like or similar elements of the surface mounted headboard. For the purposes of presenting a brief and clear description of the present invention, the preferred embodiment will be discussed as used for mounting a headboard to a surface. The figures are intended for representative purposes only and should not be considered to be limiting in any respect.

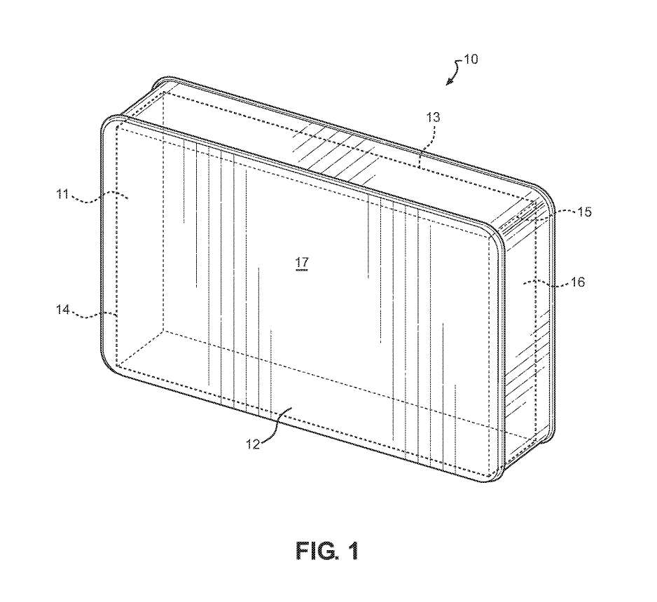

Referring now to FIG. 1, there is shown a front perspective view of the surface mounted headboard. The surface mounted headboard 10 generally comprises a base 11 having a front side 13 and a rear side 14. The rear side 14 faces the surface to which the headboard 10 is mounted while the front side 13 extends outwardly therefrom, such that a front surface 17 is parallel to the surface. The surfaces to which the headboard 10 may be mounted include a wall behind a bed, the outer surface of an existing headboard, or other surfaces.

The surface mounted headboard 10 further includes a perimeter edge 16 that encircles the base 11 and separates the front side 13 from the rear side 14. In the illustrated embodiment, the perimeter edge 16 has a uniform width. The perimeter edge 16 may also include rounded corners 15. In the illustrated embodiment, the headboard 10 is rectangular. However, the headboard 10 may be circular or any other suitable shape. Additionally, the surface mounted headboard 10 comprises a cover 12 removably securable thereto. The cover 12 may be a fabric covering that can be removed for cleaning if necessary.

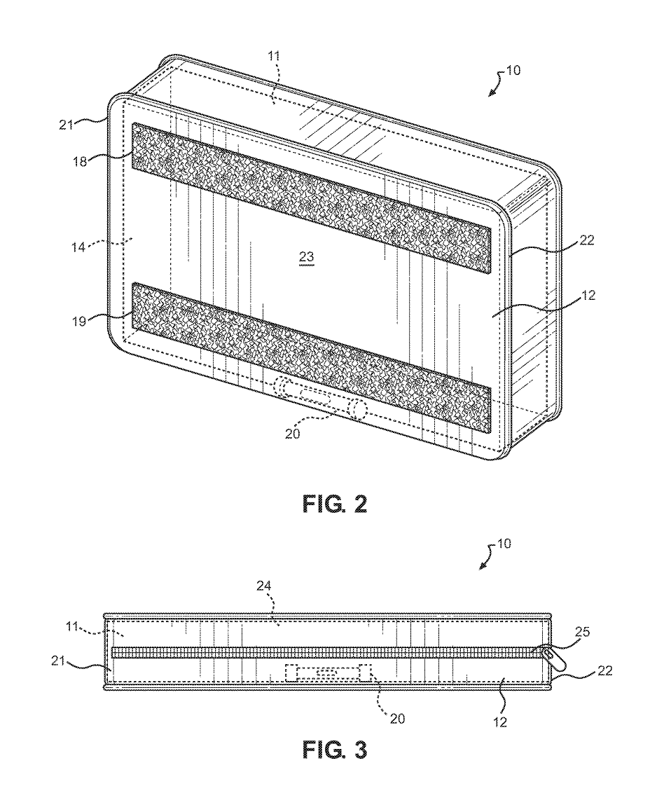

Referring now to FIG. 2, there is shown a rear perspective view of the surface mounted headboard. In one embodiment, the headboard 10 includes a bubble level 20 removably secured thereto. The bubble level 20 may be included for facilitating proper alignment and positioning during installation. In such embodiments, the bubble level 20 may be removably secured to the base 11, or alternatively may be removably secured to an interior side of the cover 12. In either embodiment, the cover 12 obscures the bubble level 20 from view when secured to the base 11.

The cover 12 comprises one or more removable fasteners disposed on an outer surface 23 thereof, which are shown as an upper removable fastener 18 and a lower removable fastener 19. In the illustrated embodiment, the upper and lower removable fasteners 18, 19 extend from a first side edge 21 of the headboard 10 to a second side edge 22 thereof. The upper and lower removable fasteners 18, 19 are positioned on the rear side 14 of the headboard 10 when the cover 12 is secured thereto.

In the illustrated embodiment, the upper and lower removable fasteners 18, 19 comprise loop material, such that a corresponding hook material having a removable adhesive backing can be adhered to a surface, and the loop material removably secured thereto. Alternate embodiments may include alternate removable upper and lower fasteners 18, 19. For instance, the removable upper and lower fasteners 18, 19 may comprise a removable adhesive that initially adheres to a surface, but can be removed from the surface without leaving residue behind and without damaging the surface.

Referring now to FIG. 3, there is shown a bottom view of the surface mounted headboard. The cover 12 includes a zippered closure 25 that allows the cover 12 to be easily attached to or removed from the base 11. The zippered closure 25 can also include other securement mechanisms such as snaps, hook and loop material, or the like. In the shown embodiment, the zippered closure 25 is disposed on the cover 12 such that it is positioned over a bottom edge 24 of the base 11 when the cover 12 is secured thereto.

In the illustrated embodiment, the bubble level 20 is disposed on the bottom edge 24 of the base 11. Alternatively, the bubble level 20 may be disposed on a flap on the interior side of the cover 12. During installation of the surface mounted headboard 10, the zippered closure 25 can be opened so that the cover 12 can be partially pulled back from the base 11, revealing the bubble level 20. The bubble level 20 can then be used to properly align and position the surface mounted headboard 10 during installation thereof. When the zippered closure 25 is fully closed, the bubble level 20 is hidden, providing a clean appearance to the surface mounted headboard 10 once it is properly secured to a surface.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A headboard, comprising:
a base having a front side and rear side;
a cover removably securable over the base;
one or more removable fasteners disposed on the cover, the one or more removable fasteners adapted to removably secure the headboard to a surface;
wherein the one or more removable fasteners are positioned over the rear side of the base when the cover is removably secured thereto.

2) The headboard of claim 1, further comprising a bubble level.

3) The headboard of claim 2, wherein the bubble level is removably secured to the base.

4) The headboard of claim 2, wherein the bubble level is removably secured to the cover.

5) The headboard of claim 1, wherein the one or more removable fasteners comprises a removable adhesive material that is removably securable to a surface.

6) The headboard of claim 5, wherein the removable adhesive material is adapted to be initially secured to a surface and then removed without damaging the surface or leaving a residue on the surface.

7) The headboard of claim 1, further comprising a perimeter edge disposed between the front side and the rear side of the base.

8) The headboard of claim 7, wherein the perimeter edge comprises a uniform width.

9) The headboard of claim 1, wherein the one or more removable fasteners comprises hook and loop material.

10) The headboard of claim 1, wherein the base has a rectangular perimeter.

11) The headboard of claim 1, wherein the base has a circular perimeter.

12) The headboard of claim 1, wherein the cover is composed of fabric.

13) The headboard of claim 1, wherein the cover comprises a zippered closure thereon for securing the cover to the base.

14) The headboard of claim 13, wherein the zippered closure is positioned over a bottom edge of the base when the cover is secured thereto.
